(19) United States
(12) Patent Application Publication
(10) Pub. No.: US 2009/0253442 A1
(43) Pub. Date: Oct. 8, 2009

(54) METHOD AND SYSTEM FOR SELECTING TIME-AND LOCATION-RELEVANT ADVERTISEMENTS

(75) Inventors: David Borrillo, Rochester, MN (US); Wade Beavers, Rochester, MN (US)

Correspondence Address: PERKINS COIE LLP, P.O. BOX 1208, SEATTLE, WA, 98111-1208, US

(73) Assignee: DoApp, Inc., Minneapolis, MN (US)

(21) Appl. No.: 12/417,584

(22) Filed: Apr. 2, 2009

Related U.S. Application Data
(60) Provisional application No. 61/041,789, filed on Apr. 2, 2008.

(51) Int. Cl. H04W 24/00

(52) U.S. Cl. 455/457

(57) ABSTRACT

A method and system for selecting relevant advertisements on a mobile device for a user. The advertisements are selected, in part, based on a user's physical location and a local time. Other criteria may also be used, such as past behaviors, user preferences, currently viewed content, and other criteria. Furthermore, a method and system calculates an itinerary for visiting a set of events, each event associated with a location and a time window. The itinerary is calculated to allow the user to arrive at each location within the time window. Upon user request, the method will also provide turn-by-turns in following the itinerary.

### CROSS REFERENCE TO RELATED APPLICATIONS

This application claims priority to provisional application No. 61/041,789 entitled “METHOD AND SYSTEM FOR SELECTING TIME-AND LOCATION-RELEVANT ADVERTISEMENTS AND ITINERARY BUILDING”, filed Apr. 2, 2008, and which is incorporated herein by reference.

### BACKGROUND

A physical location of a mobile device can be determined via various systems. A Global Positioning System (GPS) receiver system utilizes satellite signals to calculate an accurate physical location. A cellular network triangulation system utilizes received signals and signal strengths from multiple cellular towers to triangulate a physical location. A short-range wireless network detection system detects the presence of nearby access points. Because such access points have a very short range, a physical location can be approximated as the location of the access points.

Online content includes multimedia files provided to a user. For example, online advertisements can be delivered to users for the purpose of advertising. Various methods are used to deliver relevant advertisements to users. For example, Google associates text ads with content by selecting relevant text ads based on the content of specific web pages. Other companies like Amazon personalize product offerings based on perceived customer preferences and past behaviors. Unfortunately, keyword- and behavior-based advertising is now prevalent on the Internet, thus making these techniques less relevant and effective.

Traditional advertisements in media can be localized in a geographical area, such as a city, state or region of the viewers. Another method of advertising is based on zip code or general location of the viewers. Location-based advertisement targeting allows a more focused and effective advertising effort. Some attempts have been made to utilize location-based advertising on the Internet with techniques such as reverse IP analysis. Unfortunately, such attempts are not always accurate because of proxy servers, virtual private networks, virtualization, remote connections, and other technical issues. Further, such techniques are ineffective if the user is not on an IP address that can be analyzed for a physical location.

### BRIEF DESCRIPTION OF DRAWINGS

FIG. 1 illustrates an example system for providing relevant content.

FIG. 2 illustrates an example mobile device for providing relevant content.

FIG. 3 illustrates a procedure for providing relevant content.

FIG. 4A illustrates an example data structure for content.

FIG. 4B illustrates an example data entry for storing content.

### DETAILED DESCRIPTION

Content and advertisements are selected for display to a user, in part, based on a user's physical location and a local time as determined by a mobile device. Additional selection criteria can also be used, such as user demographic and user past behavior. This improves the relevancy of the selected content and advertisements, thereby improving user click-through rates and content value.

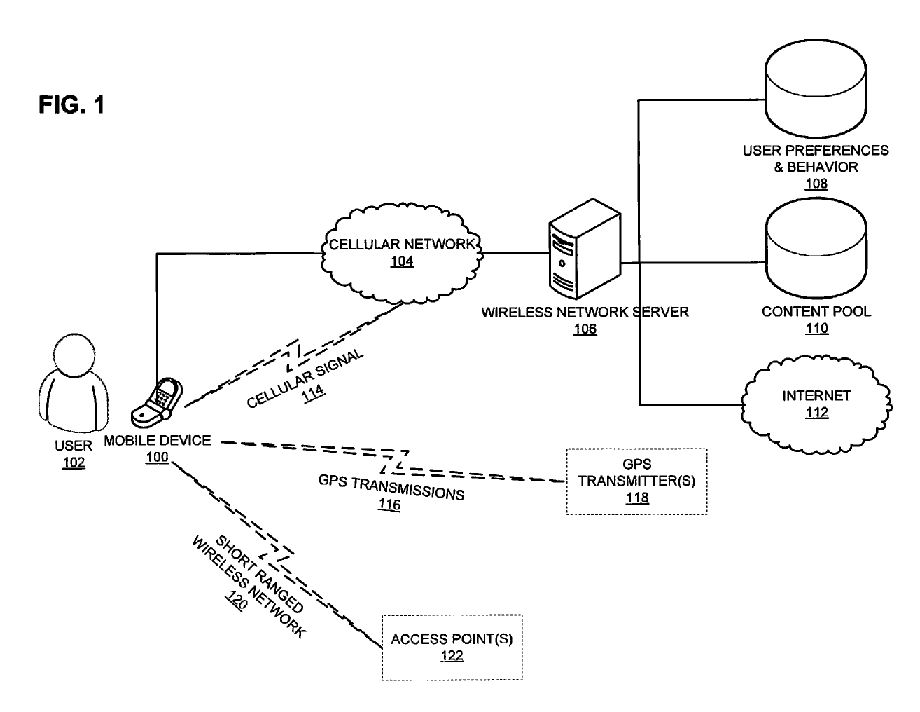

FIG. 1 illustrates an example system for providing relevant content. A mobile device 100 is used by a user 102. For example, the mobile device 100 can be a data-capable cellular phone, a wireless Personal Digital Assistant (PDA), a laptop computer, or any other mobile computing device.

The mobile device 100 is in communications with a cellular network 104. The cellular network includes a plurality of cellular towers, each tower providing wireless cellular signal coverage to a limited geographical area. The cellular network can be configured to carry both voice and data signals, and can be digital or analog. Each tower of the cellular network 104 can also transmit a local time for updating a clock on the mobile device 100. For example, the cellular network 104 can provide signal coverage to a defined geographical area.

The mobile device 100 communicates with a wireless network server 106 over the cellular network 104. The wireless network server 106 provides communication and data services to the mobile device 100, including forwarding voice and data connections/data.

The wireless network server 106 is in communications with a user preferences and behavior memory 108. The memory 108 stores user-selected preferences and past behavior, which can be relevant to content selection. For example, each user can be associated with a user identifier that identifies the user in the system. Thus, each user is associated with preferences and past behavior.

The wireless network server 106 is in communications with a content pool memory 110. The memory 110 stores content to be transmitted to the mobile device 100, including proprietary content, cached content from other sources, and advertisements. Content can be information or multimedia files as discussed above.

For example, the content pool 110 includes advertisements from merchants who pay to have their advertisements displayed to users when relevant. Such advertisements can be for products, services, branding, sales, or anything else the merchant selects. By providing advertisements to users at relevant physical locations and times, merchants will improve their advertisement effectiveness and impact.

The wireless network server 106 is in communication with the Internet 112. Additional content can be retrieved from the Internet 112 and processed by the wireless network server 106 for transmission to the mobile device 100. In addition, the wireless network server 106 can be in communication with other networks, such as private networks that provide content.

Content can include sports scores, local news, articles, and weather information. Content can also include advertisements selected from the content pool 110 based on the mobile device's local time, physical location, and the stored user preferences.

The mobile device 100 can be configured to calculate a physical location. In an alternative embodiment, the wireless network server 106 can be configured to receive information from the mobile device 100 to calculate a physical location of the mobile device 100. This minimizes the required computing resources at the mobile device 100 by performing the computing at the wireless network server 106. This can be optimal if the wireless network 104 has unused bandwidth to transmit the information and results.

In one example, the mobile device 100 can receive cellular signals 114 from one or more cellular towers. A physical location can be approximated from known tower locations and signal strengths via various triangulation techniques. For example, the wireless network server 106 can maintain a list of cellular towers and associated locations. Each cellular signal is therefore associated with a tower whose location is known. By approximating a distance from the associated cellular tower based on the signal strength, a physical location of the mobile device 100 can be calculated.

In another example, the mobile device 100 can receive GPS transmissions 116 from GPS transmitters 118. A physical location can be approximated from the received GPS transmissions and an internal time. In this example, the mobile device 100 includes a GPS receiver.

In another example, the mobile device can receive short-range wireless network signals 120 from one or more access points 122. For example, short-range wireless networks can include Bluetooth, Wi-Fi, or other protocol networks. Because of such networks have a short range, the physical location of the mobile device 100 can be approximated as the location of the access points 122 detected by the mobile device 100. The wireless network server 106 can maintain a list of access points 122 and associated locations. In this example, the mobile device 100 includes a short-range wireless network transceiver to detect such networks.

### <Any Other Methods of Determining a Physical Location?>

It will be appreciated that the above approximations can be improved in accuracy by using various optimization and refinement strategies. It will also be appreciated that other methods of calculating a physical location of the mobile device 100 can be used.

The physical location of the mobile device 100 can be transmitted to the wireless network server 106, along with a local time. The local time can be retrieved from a clock included in the mobile device 100, updated with a network time transmitted by the cellular towers, as discussed above. From this information and user preferences and behaviors (if required), relevant content can be selected and transmitted back to the mobile device 100 for display to the user 102.

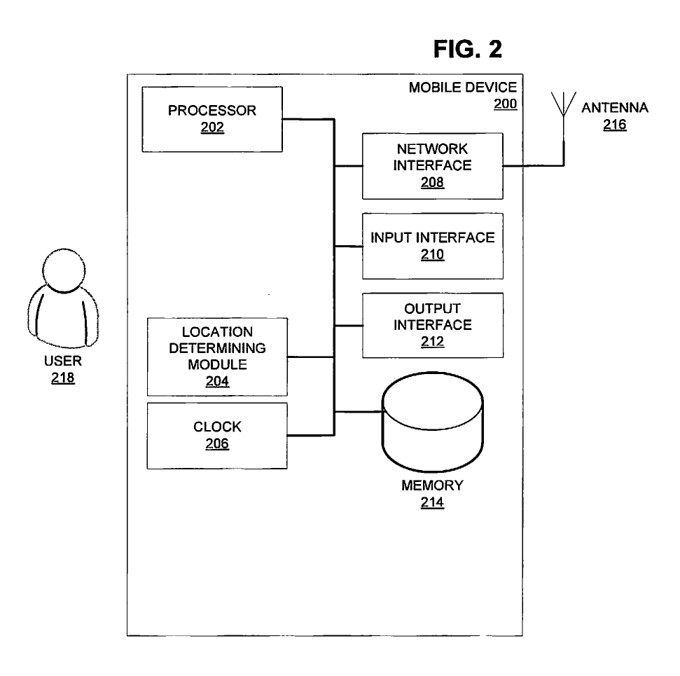

FIG. 2 illustrates an example mobile device for providing relevant content. The mobile device 200 can be a cellular phone, a PDA, a laptop computer, or any computing device configured to communicate via a network. The mobile device 200 is configured to respond to user requests and provide relevant content by displaying or otherwise outputting the content.

The mobile device 200 can include a processor 202. The processor 202 can be a general processor configured to execute computer-readable instructions operating the mobile device 200 and associated peripherals, including calculating a physical location and a local time for transmission to a server.

The mobile device 200 can include a location determining module 204. The module 204 can be a GPS receiver module configured to receive GPS signals and calculate a physical location of the mobile device 200 based on the received GPS signals and an internal clock time. The physical location calculation can be optimized by, for example, averaging the GPS signals over time or incorporating a signal from a known nearby location.

Alternatively, the module 204 can calculate a physical location by cellular signal triangulation, as discussed above. Similar strategies as discussed above regarding GPS reception can be applied to optimize cellular signal triangulation calculations.

Alternatively, the mobile device 200 can calculate a physical location via short-range wireless network detection, as discussed above. This can provide an approximation of a physical location based on the range of the short-range wireless network.

Alternatively, the module 204 can be connected to a wired network, with an IP address from which a physical location can be calculated or approximated. For example, the mobile device 200 can plug into an Ethernet jack. The IP address can be associated with a physical location of the Ethernet jack, which approximates the physical location of the mobile device 200.

The mobile device 200 can include a clock 206. The clock 206 can provide a local time for use in selecting relevant content. The clock 206 can also provide an internal time for use with the GPS module.

The mobile device 200 can include a network interface 208. For example, the network interface 208 can communicate with a cellular wireless network, a wired network such as Ethernet, or a short range wireless network. The mobile device 200 can include multiple network interfaces or a network interface configured to interface with multiple networks. Wireless network interfaces can communicate via an antenna 216.

An Ethernet network allows the mobile device 200 to communicate with a server when plugged in. The mobile device 200 can be assigned an IP address on the wired network, from which a physical location of the mobile device 200 can be calculated or approximated by the server.

A short-range wireless network can be a Wi-Fi, Wi-Bree or Bluetooth network. Because the coverage area of such wireless networks is limited, a physical location of the mobile device can be calculated or approximated as an access point location or the wireless network coverage area.

The mobile device 200 can include an input interface 210. The input interface 210 can receive user inputs from an input device and convert the user inputs into user commands. For example, input devices can include a touch screen display, a keypad, a microphone, a pointer device, a scroll wheel, or other input devices.

The mobile device 200 can include an output interface 212. The output interface 212 can transmit output to an output device in a form accessible to the user 218. For example, output devices can include a display screen, a speaker, an audio-out jack, an electromechanical motor for providing tactile output, or other output devices.

The mobile device 200 can include a memory 214. The memory 214 can be read-only or read-write, persistent or volatile memory accessible to the processor 202. The memory 214 can store data required by the mobile device 200 for execution. The memory 214 can also store cached content to be displayed to the user.

The mobile device 200 can be used by a user 218. The user can operate the mobile device 200 to retrieve and view content, and also to view server-selected relevant content selected, in part, based on the mobile device 200's physical location and local time.

In an alternative embodiment, the mobile device 200 can be in intermittent communications with a workstation, such as a personal computer. The workstation can transmit a mobile device physical location and local time to the server, and receive relevant content for forwarding to the mobile device 200. The relevant content can be cached in the memory 214 for later display to the user 218.

A mobile device 200 communicates with a cellular network as illustrated in FIG. 1, discussed above. The mobile device 200 provides mobile device functionality such as cellular voice or data communications thorough its connection to the cellular network.

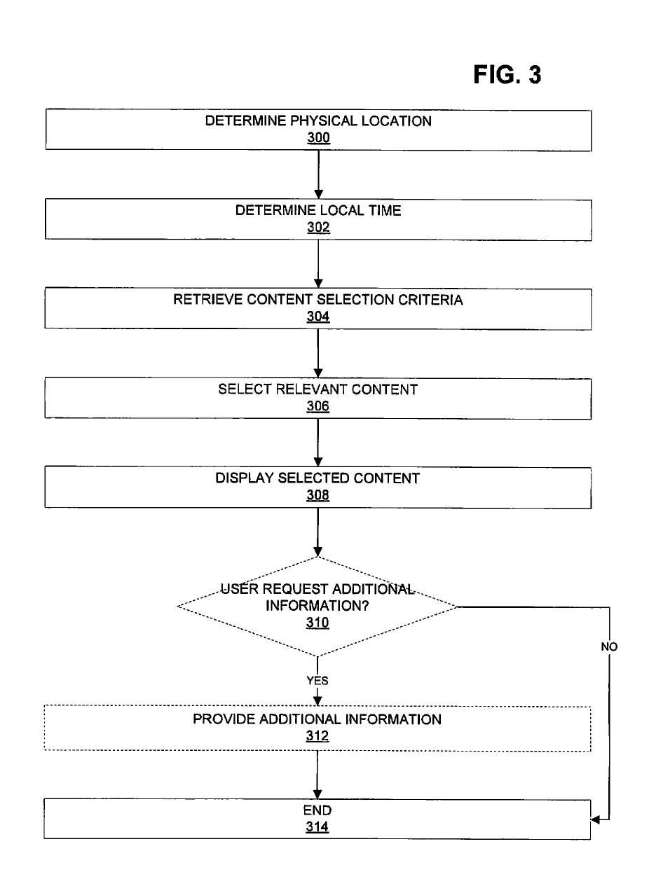

FIG. 3 illustrates a procedure for providing relevant content. The procedure can execute on a system as depicted in FIG. 1, including a mobile device as depicted in FIG. 2 in communication with a server. A user utilizes the mobile device, for example, by retrieving user-selected content or by making voice calls.

In 300, the mobile device determines a physical location. The mobile device includes functionality to determine a physical location. For example, the mobile device can utilize GPS, cellular signal triangulation, short-range wireless network detection, or other methods discussed above. The physical location can be calculated in conjunction with the server, for example, by transmitting sensor readings to the server for calculation. The physical location is be used by the server to select relevant content.

In 302, the mobile device determines a local time. For example, the mobile device includes an internal clock and receives regular update transmissions with a current time. The local time is retrieved from the internal clock or determined by another method. The local time is be used by the server to select relevant content.

In 304, the server retrieves additional content selection criteria. In addition to the physical location and the local time, traditional content selection criteria can also be used. For example, the criteria can include a user preference, a user past behavior history, or any other information helpful to selecting a relevant content for the user.

In 306, the server selects one or more content for transmission to the mobile device for display. The selection is based on the physical location, the local time, and any other criteria discussed above. The content can be selected from a pool of available content stored on an accessible medium, the content associated with a physical location relevancy and a local time relevancy. The server selects a piece of content if its physical location relevancy and local time relevancy is relevant to the mobile device.

For example, the content can be any information or other multimedia files the user requests. Alternatively, the content can be paid advertisements for display to the user, as discussed above. Relevancy can be measured by a difference function calculating the difference between a current physical location or local time with an advertiser-selected physical location or local time. The advertiser selected the advertiser-selected physical location and local time to maximize ad relevancy to the user.

In 308, the content is transmitted to the mobile device for display. For example, the content can be transmitted as data over the wireless network. The mobile device displays the content to the user.

In 310, the mobile device tests whether the user has requested additional information. For example, the user can indicate a desire to learn more after viewing a displayed advertisement. If yes, the procedure proceeds to 312. If no, the procedure ends in 314.

In 312, the mobile device transmits the request to the server, which can respond with, for example, a Uniform Resource Locator (URL) address for an advertiser website. The mobile device will load the advertiser website for display to the user. Alternatively, the server can transmit a follow-up content, such as additional product information.

In 314, the procedure ends.

In another example, the content can be pre-loaded on the mobile device and the selection of 206 is executed by the mobile device. This allows the content to be transmitted during times of low network bandwidth use.

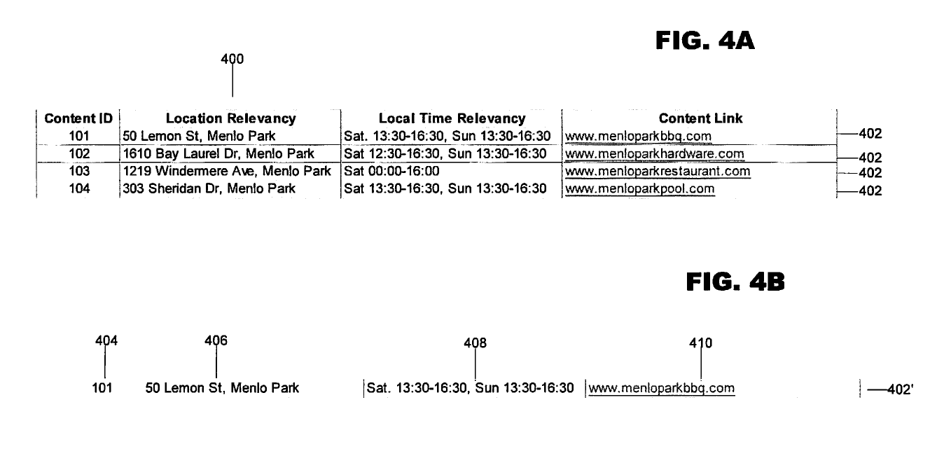

FIG. 4A illustrates an example data structure for content. A data structure 400 can be stored in an accessible memory and store content for transmission to a mobile device. Content can be any multimedia file or other content, as discussed above.

The data structure 400 can be saved in memory as a two-dimensional array, a linked list, a table, or any other data structure configured to store a set of entries. The data structure 400 can be stored in random access memory or saved to other rewritable or non-volatile memory.

The data structure can include one or more data entries 402. Each entry 402 can represent content. For example, content can include user-requested content or advertisements, as discussed above.

FIG. 4B illustrates an example data entry for storing content. Each entry 402′ represents a piece of content. The content can include graphics, text, audio, or other multimedia files.

Each entry 402′ can include a content identifier 404. The content identifier 404 can be a globally unique identifier. The content identifier 404 can be used to identify each event within memory. For example, the content identifier 404 can be a sequence of alpha-numeric characters.

Each entry 402′ can include a location relevancy 406. For example, the location relevancy 406 can be a street address, a set of longitude and latitude coordinates, or any other representation of a location. The location relevancy 406 can be used to determine when the content is relevant to a user's physical location.

Each entry 402′ can include a local time relevancy 408. For example, the local time relevancy 408 can be a period of time when the content is relevant to a user. For example, a restaurant that only serves dinner is only relevant during dinner time.

Each entry 402′ can include a content link 410. For example, the content link 410 can be a URL address of a merchant website that is provided when the user requests additional information.

<Any Other Information Stored by the System that is Relevant to Each Ad?>

It will be appreciated that each entry 402′ can include other fields, defined by programmer or user, such as a business name, graphics, user-added comments, travel directions, etc. Additional fields can provide additional functionality or options when calculating an itinerary.

As discussed above, one example embodiment of the present invention can be a method for selecting relevant content. The method comprises determining a physical location of a mobile device. The method comprises determining a local time of the mobile device. The method comprises selecting a relevant content from a pool of available content based on the physical location and local time. The method comprises transmitting the content to the mobile device for display to a user. The content may be an advertisement. The method comprises, responsive to a user indication of interest, transmitting a website URL address to the mobile device. The physical location may be determined by at least one of: a GPS module, a cellular signal triangulation module, or a short-range wireless receiver. The local time may be determined by an accessible clock. The selecting may be further based on at least one of: a user demographic, a past user behaviour, and a user-defined preference. The selecting may be further based on an itinerary purpose.

Another example embodiment of the present invention can be a system for selecting relevant content. The system comprises a mobile device. The system comprises a memory storing a pool of available content. The system comprises a server, the server in communications with the mobile device. The system may be configured to receive a determined physical location of the mobile device. The system may be configured to determine a local time of the mobile device. The system may be configured to select a relevant content from the memory based on the physical location and local time. The system may be configured to transmit the content to the mobile device for display to a user. The content may be an advertisement. The system may be configured to, responsive to a user indication of interest, transmit a website URL address to the mobile device. The physical location may be determined by at least one of: a GPS module, a cellular signal triangulation module, or a short-range wireless receiver. The local time may be determined by an accessible clock. The selecting may be further based on at least one of: a user demographic, a past user behaviour, and a user-defined preference. The content may be further selected based on an itinerary purpose.

Another example embodiment of the present invention can be a computer-readable medium including instructions adapted to execute a method for selecting relevant content. The method comprises determining a physical location of a mobile device. The method comprises determining a local time of the mobile device. The method comprises selecting a relevant content from a pool of available content based on the physical location and local time. The method comprises transmitting the content to the mobile device for display to a user. The content may be an advertisement. The method comprises, responsive to a user indication of interest, transmitting a website URL address to the mobile device. The physical location may be determined by at least one of: a GPS module, a cellular signal triangulation module, or a short-range wireless receiver. The local time may be determined by an accessible clock. The selecting may be further based on at least one of: a user demographic, a past user behaviour, and a user-defined preference. The selecting may be further based on an itinerary purpose.

It will be appreciated to those skilled in the art that the preceding examples and embodiments are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. A method for selecting relevant content, comprising:
determining a physical location of a mobile device;
determining a local time of the mobile device;
selecting a relevant content from a pool of available content based on the physical location and local time; and
transmitting the content to the mobile device for display to a user.

2. The method of claim 1, wherein the content is an advertisement.

3. The method of claim 2, further comprising:
responsive to a user indication of interest, transmitting a website URL address to the mobile device.

4. The method of claim 1, wherein the physical location is determined by at least one of: a GPS module, a cellular signal triangulation module, or a short-range wireless receiver.

5. The method of claim 1, wherein the local time is determined by an accessible clock.

6. The method of claim 1, wherein the selecting is further based on at least one of: a user demographic, a past user behavior, and a user-defined preference.

7. The method of claim 1, wherein the selecting is further based on an itinerary purpose.

8. A system for selecting relevant content, comprising:
a mobile device;
a memory storing a pool of available content; and
a server, the server in communications with the mobile device, wherein the server is configured to,
receive a determined physical location of the mobile device,
determine a local time of the mobile device,
select a relevant content from the memory based on the physical location and local time, and
transmit the content to the mobile device for display to a user.

9. The system of claim 8, wherein the content is an advertisement.

10. The system of claim 9, wherein the server is further configured to,
responsive to a user indication of interest, transmit a website URL address to the mobile device.

11. The method of claim 8, wherein the physical location is determined by at least one of: a GPS module, a cellular signal triangulation module, or a short-range wireless receiver.

12. The system of claim 8, wherein the local time is determined by an accessible clock.

13. The system of claim 8, wherein the selecting is further based on at least one of: a user demographic, a past user behavior, and a user-defined preference.

14. The system of claim 8, wherein the content is further selected based on an itinerary purpose.

15. A computer-readable medium including instructions adapted to execute a method for selecting relevant content, the method comprising:
determining a physical location of a mobile device;
determining a local time of the mobile device;
selecting a relevant content from a pool of available content based on the physical location and local time; and
transmitting the content to the mobile device for display to a user.

16. The medium of claim 15, wherein the content is an advertisement.

17. The medium of claim 16, the method further comprising:
responsive to a user indication of interest, transmitting a website URL address to the mobile device.

18. The medium of claim 15, wherein the physical location is determined by at least one of: a GPS module, a cellular signal triangulation module, or a short-range wireless receiver.

19. The medium of claim 15, wherein the local time is determined by an accessible clock.

20. The medium of claim 15, wherein the selecting is further based on at least one of: a user demographic, a past user behavior, a user-defined preference, and an itinerary purpose.
